(19) United States
(12) Patent Application Publication
(10) Pub. No.: US 2004/0011188 A1
(43) Pub. Date: Jan. 22, 2004

(54) Karaoke keyboard synthesized lyric maker

(76) Inventor: Larry W. Smith, Atlanta, GA (US)

Correspondence Address: MCKENNA LONG & ALDRIDGE LLP, Matthew T. Bailey, 1900 K Street, N.W., Washington, DC, 20006, US

(21) Appl. No.: 10/615,766

(22) Filed: Jul. 10, 2003

Related U.S. Application Data
(63) Continuation-in-part of application No. 10/010,275, filed on Mar. 7, 2002.

(51) Int. Cl. G10H 1/36; G10H 7/00

(52) U.S. Cl. 84/610

(57) ABSTRACT

A musical instrument is configured such that a display unit is provided on a main body so as to improve its function by displaying lyrics by synthesizing words with notes played on a keyboard at the time of performance.

This application is a Continuation-in-Part of co-pending application of Larry W. Smith, Ser. No. 10/010,275, filed on Mar. 7, 2002, entitled “THEM LYRIC-MAKER PATENT” (Attorney Docket Number 27342.001.00).

### BACKGROUND OF THE INVENTION

1. Field of the Invention

The present invention relates to a musical instrument such as a portable electronic keyboard, piano, or any machine. More particularly, it relates to a musical instrument, which synthesizes musical notes and lyrics (words). The combination of notes and lyrics during performance may have a karaoke function.

2. Discussion of the Related Art

There are musical instruments available that range from small, inexpensive toys for education and/or enjoyment to large and rather expensive devices for performance and/or instruction. The present invention is related to a musical instrument that can be readily transported to any place and easily played at any time. Alternatively, the present invention may be related to an upright floor model that can be stationary. There is an increased demand for a portable electronic instrument that has the same performance capabilities as a large size electronic musical instrument. A typical example is a musical keyboard synthesizer. The synthesizer is an electronic musical instrument in which various parameters necessary to form a musical tone can be set as desired by a performer. Such a portable musical instrument combines an electronic sound source with individual piano-like keys, miniature drums, or other buttons to produce sound effects.

Some electronic musical instruments, portable or otherwise, include apparatuses for visually displaying musical notes, beats and tempos. However, conventional musical instruments having a keyboard do not include lyrics enabling a karaoke performance.

### SUMMARY OF THE INVENTION

Accordingly, the present invention is directed to a karaoke keyboard synthesized lyric maker that substantially obviates one or more of the problems due to limitations and disadvantages of the related art.

An advantage of the present invention is to provide a musical instrument, portable or otherwise, that combines the functions of synthesizing, electronic keyboard tones, visual display, and karaoke.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a musical instrument comprises a main body having a keyboard, a synthesizer, and a memory unit; and a display unit disposed on the instrument main body; wherein the memory unit contains data comprising lyrics to a plurality of songs, and wherein the display unit displays the lyrics contained in the memory unit.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a musical instrument, such as a portable electronic keyboard; and

FIG. 2 illustrates a musical instrument, such as an upright electronic piano.

### DETAILED DESCRIPTION OF THE ILLUSTRATED EMBODIMENTS

Reference will now be made in detail to an embodiment of the present invention, example of which is illustrated in the accompanying drawings.

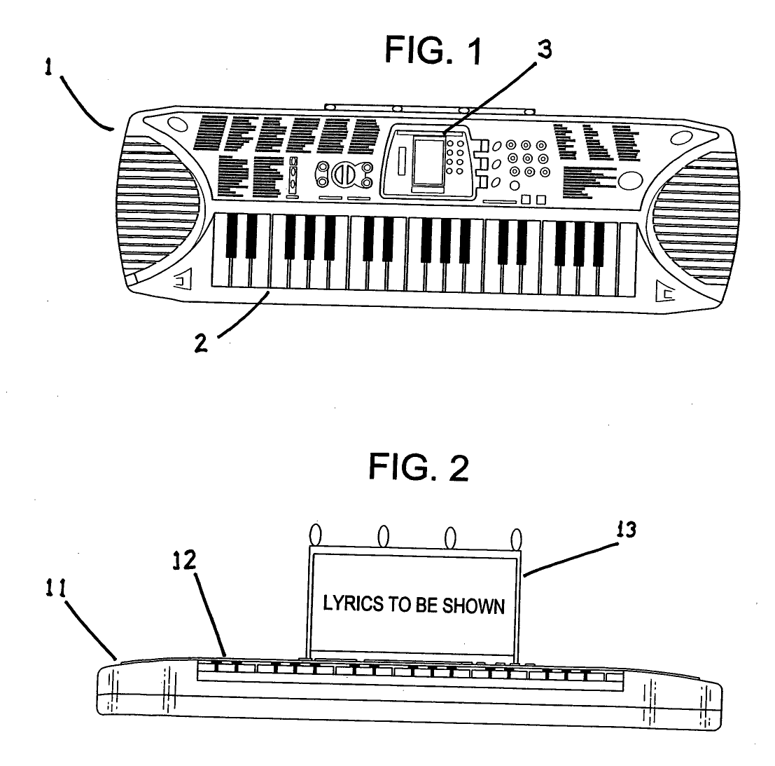

FIG. 1 illustrates a musical instrument, such as a portable electronic keyboard. The musical instrument generally includes a keyboard main body 1, a keyboard 2, and a display unit 3.

FIG. 2 illustrates a musical instrument, such as an upright electronic piano. The musical instrument generally includes a piano main body 11, a keyboard 12, and a display unit 13.

The main body of the keyboard or the piano includes a synthesizer, a sound component, and a memory unit. Whether the musical instrument is portable or otherwise, it may be manufactured with a display unit that is a built-in screen or a pop-up digital screen for displaying lyrics (words). The upright floor model may have a stationary word screen located for example, on top of the keyboard and/or a built-in digital lyric music screen inserted for example, into the center of the main body.

A musical instrument such as a keyboard can be equipped with automatic performance or automatic accompaniment, a display function for displaying lyrics, notes, and images, a sound component, a data housing, and other devices such as a recorder (magnetic tape, digital medium, memory card, or disk drive, for example), an image pick-up device, and a microphone. Since the invention may include these features, a performer does not have to turn the sheets of music or memorize words to songs. A performer can play while singing or practice with ease.

The present invention will produce words and/or lyrics instantly, sequentially, or concurrently, synchronized with the notes being played on the musical instrument, such as a keyboard. The memory unit contains data representing the lyrics to a plurality of songs. This type of musical instrument will enhance the variety of songs that performers, such as musicians, can play by request and unrehearsed. The number of sounds and lyrics that can be synthesized is unlimited. This inventive musical instrument can be applied to various kinds of electronic machines such as a computer.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A musical instrument comprising:
a main body having a keyboard, a synthesizer, and a memory unit; and
a display unit disposed on the instrument main body;
wherein the memory unit contains data comprising lyrics to a plurality of songs, and wherein the display unit displays the lyrics contained in the memory unit.

2. The musical instrument of claim 1, wherein the main body is portable.

3. The musical instrument of claim 1, wherein the main body is stationary.

4. The musical instrument of claim 1, wherein the display unit is a pop-up screen.

5. The musical instrument of claim 1, wherein the display unit is built in to the main body.

6. The musical instrument of claim 1, wherein the memory unit further contains data comprising instrumental music associated with the plurality of songs.

7. The musical instrument of claim 1, wherein the keyboard is equipped with automatic performance.

8. The musical instrument of claim 7, wherein the keyboard is equipped with automatic accompaniment.

9. The musical instrument of claim 1, further comprising a microphone.
